(19) United States
(12) Patent Application Publication
(10) Pub. No.: US 2026/0313263 A1
(43) Pub. Date: Oct. 8, 2026

(54) SEMICONDUCTOR APPARATUS

(71) Applicant: SONY SEMICONDUCTOR SOLUTIONS CORPORATION, KANAGAWA (JP)

(72) Inventor: MASAKI SAKAKIBARA, KANAGAWA (JP)

(21) Appl. No.: 19/478,726

(22) PCT Filed: Apr. 11, 2024
(86) PCT No.: PCT/JP2024/014695

§ 371 Date: Oct. 24, 2025

(30) Foreign Application Priority Data
May 2, 2023 (JP) 2023-076098

(51) Int. Cl. H04N 25/772

(52) U.S. Cl. CPC H04N 25/772

(57) ABSTRACT

[Object] To make it possible to transfer data in at least two directions. [Solving Means] A semiconductor apparatus includes a plurality of first data-transfer groups each including first flip-flops that transfer data in a first direction, with first data-transfer groups of the plurality of first data-transfer groups being arranged in a second direction that intersects the first direction; a plurality of second data-transfer groups each including second flip-flops that transfer data in the second direction, with second data-transfer groups of the plurality of second data-transfer groups being arranged in the first direction; and a switch controller that performs individual switch control on a connection destination of an output terminal of each of the first flip-flops in the plurality of first data-transfer groups and on a connection destination of an output terminal of each of the second flip-flops in the plurality of second data-transfer groups.

### TECHNICAL FIELD

The present disclosure relates to a semiconductor apparatus.

### BACKGROUND ART

A pixel-ADC image-capturing apparatus in which analog-to-digital conversion (hereinafter referred to as AD conversion) is performed by each pixel is known (refer to, for example, Patent Literature 1). In Patent Literature 1, a time code transfer section is arranged in a column direction of a pixel array section, the time code transfer section transfers a time code to each pixel, and the time code is held as an AD conversion value at a timing at which a pixel signal coincides with a reference signal.

### CITATION LIST

### Patent Literature

Patent Literature 1: WO 2018/037902

### DISCLOSURE OF INVENTION

### Technical Problem

However, the existing pixel-ADC image-capturing apparatus only makes it possible to transfer a time code in a predetermined direction and to transfer an AD conversion value for each pixel in a predetermined direction. Thus, it is not efficient in transfer. Further, a direction in which data is transferred is restricted. Thus, there are restrictions on computational processes that can be performed by a pixel array section, and there is no choice but to perform a complicated computational process using a chip that is different from the image-capturing apparatus. This results in difficulty in simplifying a configuration of an image-capturing system that includes the image-capturing apparatus.

Further, for not only image-capturing apparatuses but also semiconductor apparatuses that include a plurality of computational devices, a configuration that makes it possible to transfer, as necessary and in at least two discretionary directions, computation results of computations performed by the plurality of computational devices has not been proposed.

Thus, the present disclosure provides a semiconductor apparatus that makes it possible to transfer data in at least two directions.

### Solution to Problem

In order to solve the issues described above, the present disclosure provides a semiconductor apparatus that includes a plurality of first data-transfer groups each including first flip-flops that transfer data in a first direction, with first data-transfer groups of the plurality of first data-transfer groups being arranged in a second direction that intersects the first direction; a plurality of second data-transfer groups each including second flip-flops that transfer data in the second direction, with second data-transfer groups of the plurality of second data-transfer groups being arranged in the first direction; and a switch controller that performs individual switch control on a connection destination of an output terminal of each of the first flip-flops in the plurality of first data-transfer groups and on a connection destination of an output terminal of each of the second flip-flops in the plurality of second data-transfer groups.

An order of propagation of a clock signal input to the first flip-flops may be reverse to an order of propagation of data input to the first flip-flops, and an order of propagation of a clock signal input to the second flip-flops may be reverse to an order of propagation of data input to the second flip-flops.

A plurality of computational devices provided correspondingly to at least one of the plurality of first data-transfer groups or the plurality of second data-transfer groups may be further included, with computational devices of the plurality of computational devices being arranged in the first direction and in the second direction, and each of the plurality of computational devices may perform a computational process on the basis of an output signal output from the first flip-flop or second flip-flop corresponding to the computational device.

The plurality of computational devices may perform at least one of four basic operations of arithmetic or analog-to-digital conversion.

Each of the plurality of computational devices may input a computation result to the first flip-flop of a next stage in the same first data-transfer group as the first flip-flop outputting the output signal, or to the second flip-flop of a next stage in the same second data-transfer group as the second flip-flop outputting the output signal.

Each of the plurality of computational devices may input a computation result to the first flip-flop in the first data-transfer group different from the first data-transfer group including the first flip-flop outputting the output signal, or to the second flip-flop in the second data-transfer group different from the second data-transfer group including the second flip-flop outputting the output signal.

The switch controller may perform individual switch control on whether a computation result of computation performed by each of the plurality of computational devices is to be transferred in the first direction using a corresponding one of the plurality of first data-transfer groups or in the second direction using a corresponding one of the plurality of second data-transfer groups.

A plurality of switching devices performing switching of an output-signal path according to the switch control performed by the switch controller may be further included, the switching being performed between each of the first flip-flops in the plurality of first data-transfer groups and a corresponding one of the second flip-flops in the plurality of second data-transfer groups.

Switching devices of the plurality of switching devices may be connected between an input node of each of the first flip-flops and an output node of a corresponding one of the plurality of computational devices and between an input node of a corresponding one of the second flip-flops and the output node of the computational device.

A plurality of first output buffers outputting, in the first or second direction, computation results of computations performed by the plurality of computational devices; and a plurality of second output buffers outputting, in a direction opposite to the first or second direction, the computation results of computations performed by the plurality of computational devices may be further included, and the switch controller may input the computation results of computations performed by the plurality of computational devices to the first flip-flops or the second flip-flops through the plurality of first output buffers or the plurality of second output buffers.

The plurality of first data-transfer groups, the plurality of second data-transfer groups, and the plurality of computational devices may be arranged in a single semiconductor layer or divided to be arranged in a plurality of semiconductor layers.

The plurality of first data-transfer groups and the plurality of second data-transfer groups may transfer data including at least one of an opcode for each of the plurality of computational devices, an operand, a computed time code, identification information regarding the computational device to which next input is performed, or computation-termination information.

The first data-transfer groups of the plurality of first data-transfer groups may transfer, in parallel, data up to an end in the first direction, and the second data-transfer groups of the plurality of second data-transfer groups may transfer, in parallel, data up to an end in the second direction.

Data transferred by a portion of the plurality of first data-transfer groups up to a first end in the first direction may be transferred by the first data-transfer groups other than the portion up to a second end in a direction opposite to the first direction, and the second data-transfer groups of the plurality of second data-transfer groups may transfer, in parallel, data up to an end in the second direction.

The first data-transfer groups of the plurality of first data-transfer groups may transfer, in parallel, data up to an end in the first direction, and data transferred by a portion of the plurality of second data-transfer groups up to a first end in the second direction may be transferred by the second data-transfer groups other than the portion up to a second end in a direction opposite to the second direction.

Data transferred by a portion of the plurality of first data-transfer groups up to a first end in the first direction may be transferred by the first data-transfer groups other than the portion up to a second end in a direction opposite to the first direction, and data transferred by a portion of the plurality of second data-transfer groups up to a third end in the second direction may be transferred by the second data-transfer groups other than the portion up to a fourth end in a direction opposite to the second direction.

The plurality of first data-transfer groups may perform data transfer in the first direction and data transfer in a direction opposite to the first direction alternately in an order of arrangement in the second direction.

The plurality of second data-transfer groups may perform data transfer in the second direction and data transfer in a direction opposite to the first direction alternately in an order of arrangement in the first direction.

Each of the first flip-flops may output, from an output node of the first flip-flop, a signal having the same logic as an input signal when a clock signal has a first logic, and causes the output node to exhibit a high impedance when the clock signal has a second logic, and each of the second flip-flops may output, from an output node of the second flip-flop, a signal having the same logic as an input signal when a clock signal has the first logic, and causes the output node to exhibit a high impedance when the clock signal has the second logic.

Each of the first flip-flops may intake the input signal when the clock signal has the second logic, and may thereafter output, from the output node of the first flip-flop, a signal having the same logic as the intaken input signal when logic of the clock signal is changed to the first logic, and each of the second flip-flops may intake the input signal when the clock signal has the second logic, and may thereafter output, from the output node of the second flip-flop, a signal having the same logic as the intaken input signal when logic of the clock signal is changed to the first logic.

### BRIEF DESCRIPTION OF DRAWINGS

FIG. 1 is a block diagram schematically illustrating a configuration of a semiconductor apparatus 1 according to an embodiment.

FIG. 2 is a circuit diagram illustrating a connection mode of first flip-flops in a first data-transfer group.

FIG. 3A illustrates states of respective transistors in a dynamic FF when a clock signal is low.

FIG. 3B illustrates the states of the respective transistors in the dynamic FF when the clock signal is high.

FIG. 4 is a block diagram schematically illustrating the configuration of the semiconductor apparatus according to a modification of the present embodiment.

FIG. 5 illustrates examples of functions of a plurality of switching devices provided for each computational device.

FIG. 6A illustrates an example of arranging nine computational devices in total that include three computational devices in a first direction and three computational devices in a second direction.

FIG. 6B illustrates a normal order of output of computation results.

FIG. 6C illustrates an order of output of computation results after transposition.

FIG. 7 is a block diagram of the semiconductor apparatus according to the modification illustrated in FIG. 4.

FIG. 8A illustrates arrangement of a plurality of computational devices.

FIG. 8B illustrates an example of reading, on a row-by-row basis, computation results of computations performed by the plurality of computational devices, using a plurality of first data-transfer groups 2.

FIG. 8C illustrates a storage region of a frame memory.

FIG. 8D illustrates an example of reading computation results from the frame memory.

FIG. 9 is a block diagram illustrating more detailed configurations of a plurality of first data-transfer groups and a plurality of second data-transfer groups that are illustrated in FIG. 4.

FIG. 10 illustrates an example in which a plurality of first data-transfer groups transfers data in the first direction and a plurality of second data-transfer groups transfers data in the second direction.

FIG. 11 illustrates an example in which first data-transfer groups of a plurality of first data-transfer groups in odd-numbered rows transfer data in a direction opposite to a direction in which first data-transfer groups of the plurality of first data-transfer groups in even-numbered rows transfer data.

FIG. 12 illustrates an example in which second data-transfer groups of a plurality of second data-transfer groups in odd-numbered columns transfer data in a direction opposite to a direction in which second data-transfer groups of the plurality of second data-transfer groups in even-numbered columns transfer data.

FIG. 13 illustrates an example in which first data-transfer groups of a plurality of first data-transfer groups in odd-numbered rows transfer data in a direction opposite to a direction in which first data-transfer groups of the plurality of first data-transfer groups in even-numbered rows transfer data and second data-transfer groups of a plurality of second data-transfer groups in odd-numbered columns transfer data in a direction opposite to a direction in which second data-transfer groups of the plurality of second data-transfer groups in even-numbered columns transfer data.

FIG. 14 is a schematic perspective view of the semiconductor apparatus having a stacking structure according to the present embodiment.

FIG. 15 is a block diagram of a first semiconductor substrate.

FIG. 16 is a block diagram of a second semiconductor substrate.

FIG. 17 is a block diagram of the second semiconductor substrate according to a modification of FIG. 16.

FIG. 18 is a block diagram illustrating a first example of an internal configuration of the computational device.

FIG. 19 is a block diagram illustrating a second example of the internal configuration of the computational device when the semiconductor apparatus is a pixel-ADC image-capturing apparatus.

FIG. 20 is a block diagram depicting an example of schematic configuration of a vehicle control system.

FIG. 21 is a diagram of assistance in explaining an example of installation positions of an outside-vehicle information detecting section and an imaging section.

### CODE(S) FOR CARRYING OUT THE INVENTION

Embodiments of a semiconductor apparatus are described below with reference to the drawings. The description is made below focused on primary structural elements of the semiconductor apparatus. However, the semiconductor apparatus may include a structural element or function that is not illustrated or described. The following description does not mean that the structural element or function not being illustrated or described is excluded.

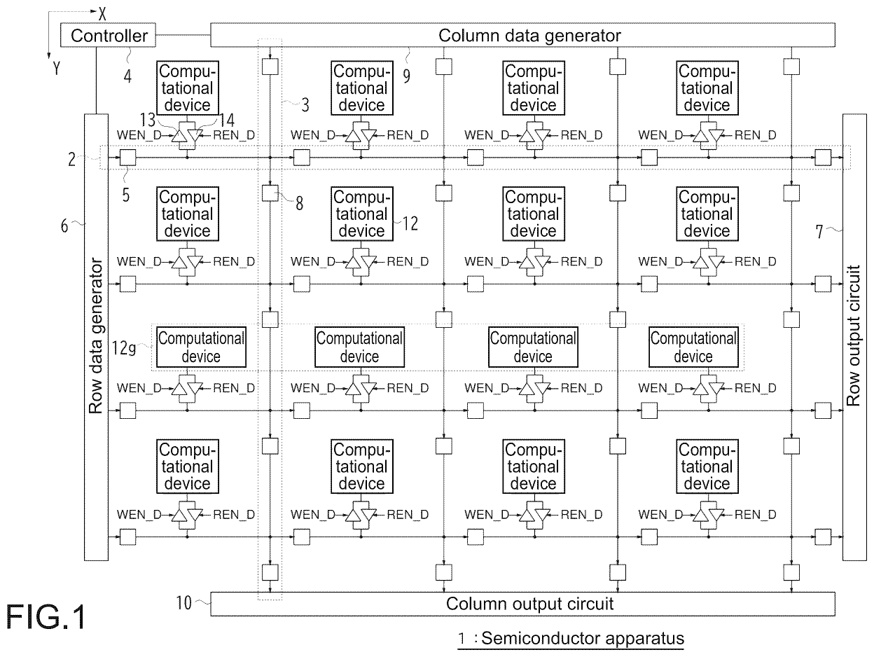

FIG. 1 is a block diagram schematically illustrating a configuration of the semiconductor apparatus 1 according to the embodiment. The semiconductor apparatus 1 illustrated in FIG. 1 is an apparatus that is arranged on at least one semiconductor substrate (not illustrated). The semiconductor apparatus 1 illustrated in FIG. 1 includes a plurality of first data-transfer groups 2, a plurality of second data-transfer groups 3, and a controller (a switch controller) 4.

First data-transfer groups 2 of the plurality of first data-transfer groups 2 are arranged in a second direction (for example, a vertical direction) Y that intersects a first direction (for example, a horizontal direction) X. Each of the plurality of first data-transfer groups 2 includes first flip-flops 5 that transfer data in the first direction X. The first flip-flops 5 of the plurality of first flip-flops 5 are connected in series. Any number may be adopted as the number of first flip-flops 5 connected in series.

A row data generator 6 is connected to a data input terminal D of the first flip-flop 5 of a first stage in each of the plurality of first data-transfer groups 2. The row data generator 6 generates data that is input to the data input terminal D of the first flip-flop 5 of the first stage in each first data-transfer group 2. A row output circuit 7 is connected to a data output terminal Q of the first flip-flop 5 of a last stage in each first data-transfer group 2. The row output circuit 7 is a circuit that outputs, to the outside of the semiconductor apparatus 1, data that is output from the data output terminal Q of the first flip-flop 5 of the last stage in each first data-transfer group 2. As described later, a memory (a frame memory that is a more specific example) may be connected to the row output circuit 7, and the data output from the data output terminal Q of the first flip-flop 5 of the last stage may be stored in the semiconductor apparatus 1.

Second data-transfer groups 3 of the plurality of second data-transfer groups 3 are arranged in the first direction X. Each of the plurality of second data-transfer groups 3 includes second flip-flops 8 that transfer data in the second direction Y. The second flip-flops 8 of the plurality of second flip-flops 8 are connected in series. Any number may be adopted as the number of second flip-flops 8 connected in series.

A column data generator 9 is connected to a data input terminal D of the first flip-flop 5 of a first stage in each second data-transfer group 3. A column output circuit 10 is connected to a data output terminal Q of the second flip-flop 8 of a last stage in each second data-transfer group 3. The column output circuit 10 is a circuit that outputs, to the outside of the semiconductor apparatus 1, data that is output from the data output terminal Q of the second flip-flop 8 of the last stage in each second data-transfer group 3. A memory may be connected to the column output circuit 10, and the data output from the data output terminal Q of the second flip-flop 8 of the last stage may be stored in the semiconductor apparatus 1.

The row data generator 6 and the column data generator 9 are controlled by the controller 4. Further, the controller 4 performs individual switch control on a connection destination of the output terminal of each of the first flip-flops 5 in the plurality of first data-transfer groups 2 and on a connection destination of the output terminal of each of the second flip-flops 8 in the plurality of second data-transfer groups 3.

As described above, a plurality of first data-transfer groups 2 and a plurality of second data-transfer groups 3 are combined discretionarily in the semiconductor apparatus 1 according to the present embodiment. This makes it possible to switch a data-transfer direction to the first direction X or second direction Y as necessary. This makes it possible to transfer data in not only the first direction X or the second direction Y but also any direction.

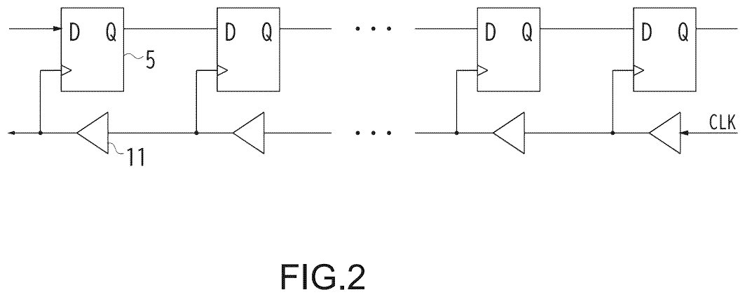

FIG. 2 is a circuit diagram illustrating a connection mode of the first flip-flops 5 in the first data-transfer group 2. A connection mode of the second flip-flops 8 in the second data-transfer group 3 is represented using a circuit diagram similar to the circuit diagram illustrated in FIG. 2. Thus, the connection mode of the first flip-flops 5 is described below, and a detailed description of the connection mode of the second flip-flops 8 is omitted.

As illustrated in FIG. 2, the data output terminal Q of each first flip-flop 5 is connected to the data input terminal D of the first flip-flop 5 of a next stage. Further, a clock signal CLK that is output from a clock buffer 11 is input to a clock terminal of a corresponding one of the first flip-flops 5. The clock buffers 11 respectively corresponding to the first flip-flops 5 are connected in series, where the clock buffer 11 of a first stage is provided correspondingly to the first flip-flop 5 of a last stage, and the clock buffer 11 of a last stage is provided correspondingly to the first flip-flop 5 of a first stage. In other words, the clock signal CLK is input earliest to the clock terminal of the first flip-flop 5 of the last stage, and the clock signal CLK is input latest to the clock terminal of the first flip-flop 5 of the first stage.

As described above, an order of propagation of a clock signal CLK input to the first flip-flops 5 is reverse to an order of propagation of data input to the first flip-flops 5. Likewise, an order of propagation of a clock signal CLK input to the second flip-flops 8 is reverse to an order of propagation of data input to the second flip-flops 8.

When setting is performed such that an order of propagation of a clock signal CLK is reverse to an order of propagation of data, this enables each of the first flip-flop 5 and the second flip-flop 8 to intake input data using a clock signal CLK in a state in which a time to set up the input data and a time to hold the input data are sufficiently secured. This results in not causing an error in intaking input data. This makes it possible to stabilize operations respectively performed by the first flip-flop 5 and the second flip-flop 8. Further, there is no need to devise something for a circuit in order to secure the setup time and the holding time for each of the first flip-flop 5 and the second flip-flop 8. This makes it possible to simplify the circuit configuration.

Each of the first flip-flop 5 and second flip-flop 8 according to the present embodiment may be a dynamic flip-flop (hereinafter referred to as a dynamic FF) that includes a true single phase clock (TSPC).

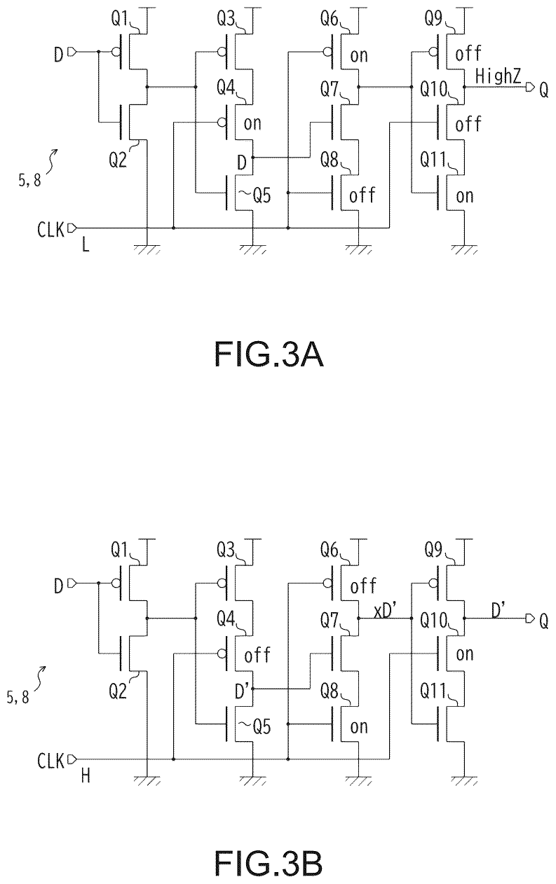

FIGS. 3A and 3B each illustrate a circuit configuration of a dynamic FF and states of respective transistors. A dynamic FF having the circuit configuration illustrated in each of FIGS. 3A and 3B can be applied to the first flip-flop 5 and the second flip-flop 8.

FIG. 3A illustrates each transistor in an on state or an off state when a clock signal CLK is low, and FIG. 3B illustrates each transistor in the on state or the off state when the clock signal CLK is high.

Each of the dynamic FFs illustrated in FIGS. 3A and 3B includes a PMOS transistor Q1, an NMOS transistor Q2, PMOS transistors Q3 and Q4, an NMOS transistor Q5, a PMOS transistor Q6, NMOS transistors Q7 and Q8, a PMOS transistor Q9, and NMOS transistors Q10 and Q11, where the PMOS transistor Q1 and the NMOS transistor Q2 are connected between a power supply voltage node and a ground node, the PMOS transistors Q3 and Q4 and the NMOS transistor Q5 are connected in a cascode arrangement between the power supply voltage node and the ground node, the PMOS transistor Q6 and the NMOS transistors Q7 and Q8 are connected in a cascode arrangement between the power supply voltage node and the ground node, and the PMOS transistor Q9 and the NMOS transistors Q10 and Q11 are connected in a cascode arrangement between the power supply voltage node and the ground node.

Gates of the respective transistors Q1 and Q2 are connected to the data input terminal D. Drains of the respective transistors Q1 and Q2 are connected to gates of the respective transistors Q3 and Q5. A clock signal CLK is input to a gate of the transistor Q4. The clock signal CLK is input to gates of the respective transistors Q6 and Q8. A gate of the transistor Q7 is connected to drains of the respective transistors Q4 and Q5. Gates of the respective transistors Q9 and Q11 are connected to drains of the respective transistors Q6 and Q7. The clock signal CLK is input to a gate of the transistor Q10. Drains of the respective transistors Q9 and Q10 are connected to the data output terminal Q.

When the level of the clock signal CLK is low, the transistor Q4 is turned on. Inverse data of input data input to the data input terminal D is input to the gates of the respective transistors Q3 and Q5, and the transistor Q4 is on. Thus, the drains of the respective transistors Q4 and Q5 (the gate of the transistor Q7) have the same logic as the input data.

When the level of the clock signal CLK is low, the transistor Q6 is turned on, and the transistor Q8 is turned off. Thus, the level of each of the drains of the transistors Q6 and Q7 is high. Therefore, the transistor Q9 is turned off, and the transistor Q11 is turned on. Further, the transistor Q10 is turned off since the level of the clock signal CLK is low.

As described above, when the level of the clock signal CLK is low, both of the transistors Q9 and Q10 are turned off, and the drains of the respective transistors Q9 and Q10 each exhibit a high impedance.

As described above, when the level of the clock signal CLK is low, input data input to the data input terminal is intaken into the dynamic FF, and the drains of the respective transistors Q4 and Q5 have a logic corresponding to the input data. However, both of the respective transistors Q9 and Q10 are turned off. Thus, the data output terminal connected to the drains of the respective transistors Q9 and Q10 exhibits a high impedance.

When the level of the clock signal CLK is high, the transistor Q4 is turned off, the transistor Q6 is turned off, the transistor Q8 is turned on, and the transistor Q10 is turned on, as illustrated in FIG. 3B. The drains of the respective transistors Q4 and Q5 have the same logic as input data, and the drains of the respective transistors Q6 and Q7 have a logic inverse of the input data. Thus, the data output terminal connected to the drains of the transistors Q9 and Q10 has the same logic as the input data.

As illustrated in FIGS. 3A and 3B, each of the first flip-flops 5 outputs, from an output node of the first flip-flop 5, a signal having the same logic as an input signal when a clock signal has a first logic, and causes the output node to exhibit a high impedance when the clock signal has a second logic. Each of the second flip-flops 8 outputs, from an output node of the second flip-flop 8, a signal having the same logic as an input signal when a clock signal has the first logic, and causes the output node to exhibit a high impedance when the clock signal has the second logic. Each of the first flip-flops 5 intakes the input signal when the clock signal has the second logic. Thereafter, the first flip-flop 5 outputs a signal having the same logic as the intaken input signal when the logic of the clock signal is changed to the first logic. Each of the second flip-flops 8 intakes the input signal when the clock signal has the second logic. Thereafter, the second flip-flop 8 outputs a signal having the same logic as the intaken input signal when the logic of the clock signal is changed to the first logic.

As described above, the dynamic FF illustrated in each of FIGS. 3A and 3B intakes input data but the output exhibits a high impedance while the level of a clock signal CLK is low. When the level of the clock signal CLK is high, data having the same logic as the input data is output from the data output terminal without any delay.

For example, the semiconductor apparatus 1 according to the present embodiment includes a plurality of computational devices 12, as illustrated in FIG. 1. The plurality of computational devices 12 is provided correspondingly to at least one of a plurality of first data-transfer groups 2 or a plurality of second data-transfer groups 3, and is arranged in the first direction X and in the second direction Y. As a more specific example, the number of the plurality of computational devices 12 arranged is one fewer than the number of first flip-flops 5 in each first data-transfer group 2. In the example illustrated in FIG. 1, four computational devices 12 are provided for five first flip-flops 5 included in each first data-transfer group 2.

Note that any specific number of computational devices 12 and any arrangement position of the computational device 12 are adopted, and the number and the arrangement position are not necessarily limited to the number and arrangement position being illustrated in FIG. 1. For example, the computational device 12 performs four basic operations of arithmetic or an analog-to-digital conversion (AD conversion) process. Note that the computational device 12 may perform a computational process other than the four basic operations of arithmetic and the AD conversion.

In the example illustrated in FIG. 1, four computational devices 12 arranged in the first direction X are grouped into a computational-device group 12g, and the computational-device groups 12g of a plurality of computational-device groups 12g are arranged in the second direction Y. Each computational-device group 12g is associated with a corresponding one of the first data-transfer groups 2. An input buffer 13 and an output buffer 14 are arranged between each computational device 12 and a corresponding first data-transfer group 2. The input buffer 13 inputs, to the computational device 12, output data output from a corresponding first flip-flop 5 when, for example, the level of an enable signal WEN is high. The output buffer 14 inputs a computation result of computation performed by the computational device 12 to the first flip-flop 5 of a next stage or a corresponding second flip-flop 8 when, for example, the level of an enable signal REN is high.

As described above, each computational device 12 performs a specified computational process on the basis of output data output from a corresponding first flip-flop 5. A computation result of computation performed by each computational device 12 is transferred by the first data-transfer group 2 including the first flip-flops 5 or by the second data-transfer group 3 including the second flip-flops 8.

As illustrated in FIG. 2, the first data-transfer group 2 includes the first flip-flops 5 and the clock buffers (first clock buffers) 11, and the second data-transfer group 3 includes the second flip-flops 8 and the clock buffers (second clock buffers) 11. When a clock signal CLK is propagated using the first clock buffers 11 or the second clock buffers 11, this makes it possible to switch between transferring, using the first data-transfer group 2, a computation result of computation performed by the computational device 12 and transferring the computation result using the second data-transfer group 3.

Note that an enable terminal may be provided to each of the first flip-flop 5 and the second flip-flop 8, and switching between transferring data in the first direction X and transferring the data in the second direction Y may be performed using a signal input to the enable terminal.

In FIG. 1, the first computational-device group 12g and the first data-transfer group 2 are associated with each other, and the input buffer 13 and the output buffer 14 are connected between each computational device 12 and a corresponding first flip-flop 5. However, the first computational-device group 12g and the second data-transfer group 3 may be associated with each other, and the input buffer 13 and the output buffer 14 may be connected between each computational device 12 and a corresponding second flip-flop 8.

As described above, the computational devices 12 of a plurality of computational devices 12 each input a computation result to the first flip-flop 5 of a next stage in the same first data-transfer group 2 as the first flip-flop 5 outputting an output signal, or to the second flip-flop 8 of a next stage in the same second data-transfer group 3 as the second flip-flop 8 outputting an output signal. Alternatively, the computational devices 12 of a plurality of computational devices 12 each input a computation result to the first flip-flop 5 in the first data-transfer group 2 different from the first data-transfer group 2 of the first flip-flop 5 outputting an output signal, or to the second flip-flop 8 in the second data-transfer group 3 different from the second data-transfer group 3 of the second flip-flop 8 outputting an output signal.

The controller 4 performs individual switch control on whether a computation result of computation performed by each of the plurality of computational devices 12 is to be transferred in the first direction X using a corresponding one of the plurality of first data-transfer groups 2 or in the second direction Y using a corresponding one of the plurality of second data-transfer groups 3.

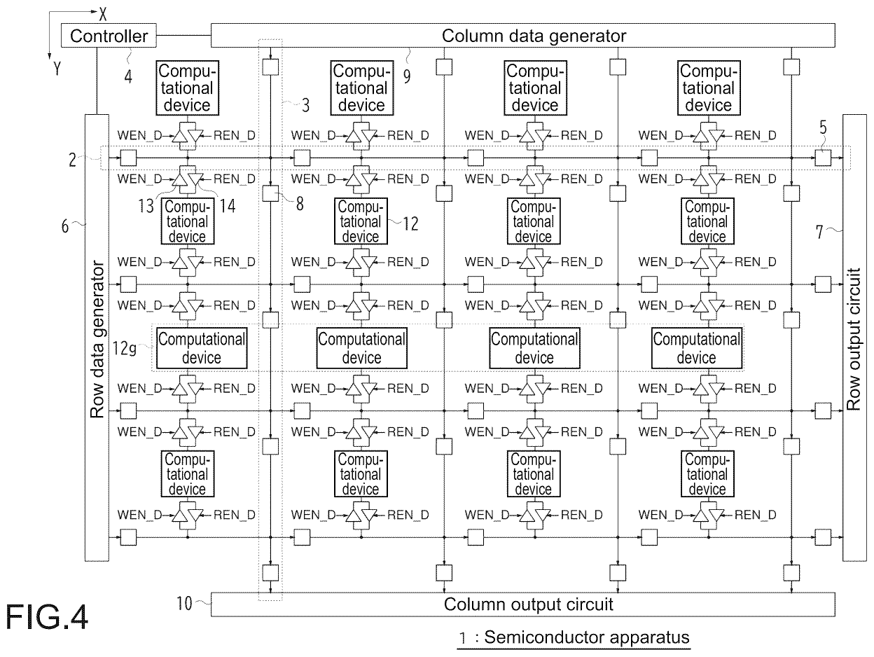

FIG. 4 is a block diagram schematically illustrating the configuration of the semiconductor apparatus 1 according to a modification of the present embodiment. In the semiconductor apparatus 1 according to the modification, the computational-device group 12g including a plurality of computational devices 12 arranged in the first direction X is associated with two first data-transfer groups 2 adjacent to each other in the second direction Y, and the input buffer 13 and the output buffer 14 are connected between each computational device 12 and a corresponding first flip-flop 5 in each of the first data-transfer groups 2.

In the semiconductor apparatus 1 according to the modification, the input buffer 13 and the output buffer 14 are arranged between each computational device 12 and each of the two first data-transfer groups 2, as described above. An individual control can be performed on an enable signal input to an enable terminal of the input buffer 13 and on an enable signal input to an enable terminal of the output buffer 14. Thus, output data output from the first flip-flop 5 included in one of the two first data-transfer groups 2 can be intaken into the computational device 12 to perform a computational process on the output data, and a result of the computation can be output from one of two output buffers 14 to transfer the computation result using the first data-transfer group 2 or the second data-transfer group 3.

This makes it possible to perform setting such that, for example, a data-transfer direction in an odd-numbered row and a data-transfer direction in an even-numbered row are opposite to each other or a data-transfer direction in an odd-numbered column and a data-transfer direction in an even-numbered column are opposite to each other.

The semiconductor apparatus 1 according to the present embodiment makes it possible to output computation results of computations performed by a plurality of computational devices 12, according to an order of arrangement of the plurality of computational devices 12 using a plurality of first data-transfer groups 2, or to output the computation results according to an order determined by transposing the plurality of arranged computational devices 12 using the plurality of first data-transfer groups 2 and a plurality of second data-transfer groups 3. As described above, the order of output of computation results of computations performed by a plurality of computational devices 12 can be easily switched by providing a plurality of switching devices for each computational device 12.

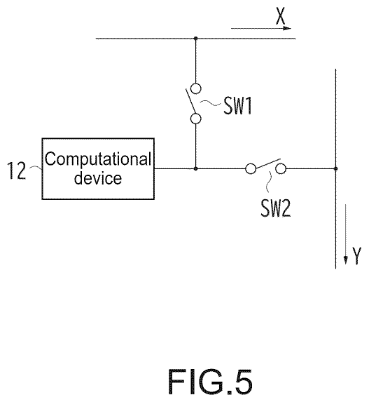

FIG. 5 illustrates examples of functions of a plurality of switching devices SW1 and SW2 provided for each computational device 12. The semiconductor apparatus 1 according to the present embodiment includes a first switching device SW1 and a second switching device SW2 for each computational device 12, where the first switching device SW1 is arranged between the computational device 12 and a corresponding first data-transfer group 2 and the second switching device SW2 is arranged between the computational device 12 and a corresponding second data-transfer group 3.

One of the first switching device SW1 and the second switching device SW2 is closed exclusively and another of the first switching device SW1 and the second switching device SW2 is opened exclusively. When, for example, the first switching device SW1 is closed, a computation result of computation performed by the computational device 12 is transferred through the first data-transfer group 2 in the first direction X. When the second switching device SW2 is closed, the computation result of computation performed by the computational device 12 is transferred through the second data-transfer group 3 in the second direction Y.

The first switching device SW1 and second switching device SW2 illustrated in FIG. 5 can be configured using the input buffer 13 and output buffer 14 illustrated in, for example, FIG. 1. The output buffers 14 include first output buffers that output, in the first direction X or the second direction Y, computation results of computations performed by the computational devices 12, and second output buffers that output, in a direction opposite to the first direction X or the second direction Y, the computation results of computations performed by the computational devices 12. The controller 4 inputs the computation results of computations performed by the computational devices 12 to the first output buffers or the second output buffers through the first output buffers or the second output buffers.

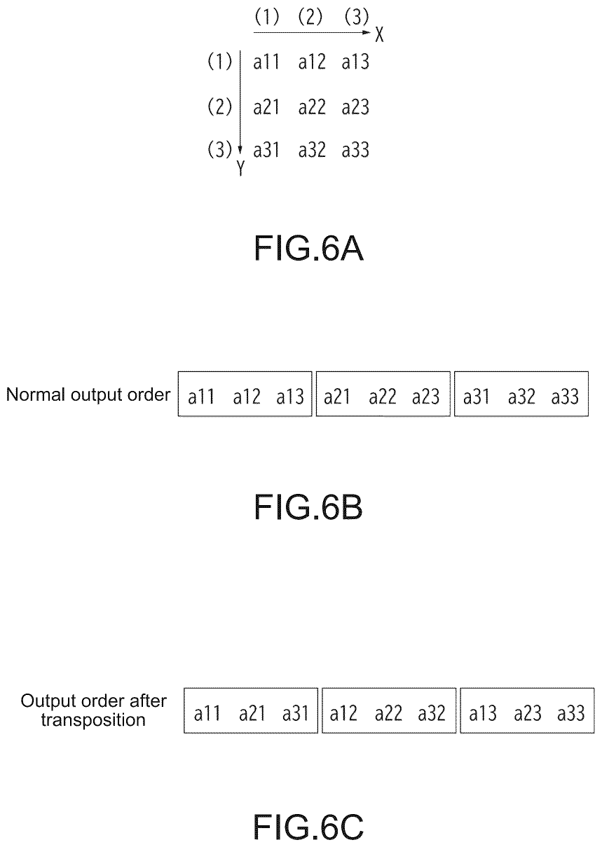

FIG. 6A illustrates an example of arranging nine computational devices 12 in total that include three computational devices 12 in the first direction X (for example, in a row direction) and three computational devices 12 in the second direction Y (for example, in a column direction). Computation results of computations performed by the nine computational devices 12 are normally transferred to be output successively in the first direction X, as illustrated in FIG. 6B. In this case, the first switching device SW1 illustrated in FIG. 5 is closed, and the second switching device SW2 illustrated in FIG. 5 is opened. As a result, computation results a11, a12, and a13 in the first row are output successively, computation results a21, a22, and a23 in the second row are subsequently output successively, and computation results a31, a32, and a33 in the third row are finally output successively, as illustrated in FIG. 6B.

When the computation results of computations performed by the nine computational devices 12 that are illustrated in FIG. 6A are output after transposition, the first switching device SW1 illustrated in FIG. 5 is opened and the second switching device SW2 illustrated in FIG. 5 is closed. As a result, computation results a11, a21, and a31 in the first column are output successively, computation results a12, a22, and a32 in the second column are subsequently output successively, and computation results a13, a23, and a33 in the third column are finally output successively, as illustrated in FIG. 6C.

For each computational device 12, the first switching device SW1 is provided between the computational device 12 and the first data-transfer group 2, and the second switching device SW2 is provided between the computational device 12 and the second data-transfer group 3, as described above. This makes it possible to easily switch between successive output based on rows of a plurality of computational devices 12 and successive output based on columns of the plurality of computational devices 12.

The example in which the first switching device SW1 and the second switching device SW2 are provided for each computational device 12 to switch the transfer order has been described with reference to FIG. 5. However, instead of providing the first switching device SW1 and the second switching device SW2 for each computational device 12, computation results of computations performed by the computational devices 12 that are transferred using the respective first data-transfer groups 2 may be stored in a frame memory, and after the computation results of computations performed by the computational devices 12 that are transferred using the first data-transfer groups 2 are stored in the frame memory, the order of reading of the computation results from the frame memory may be switched to select whether the computation results are to be output on a row-by-row basis or on a column-by-column basis.

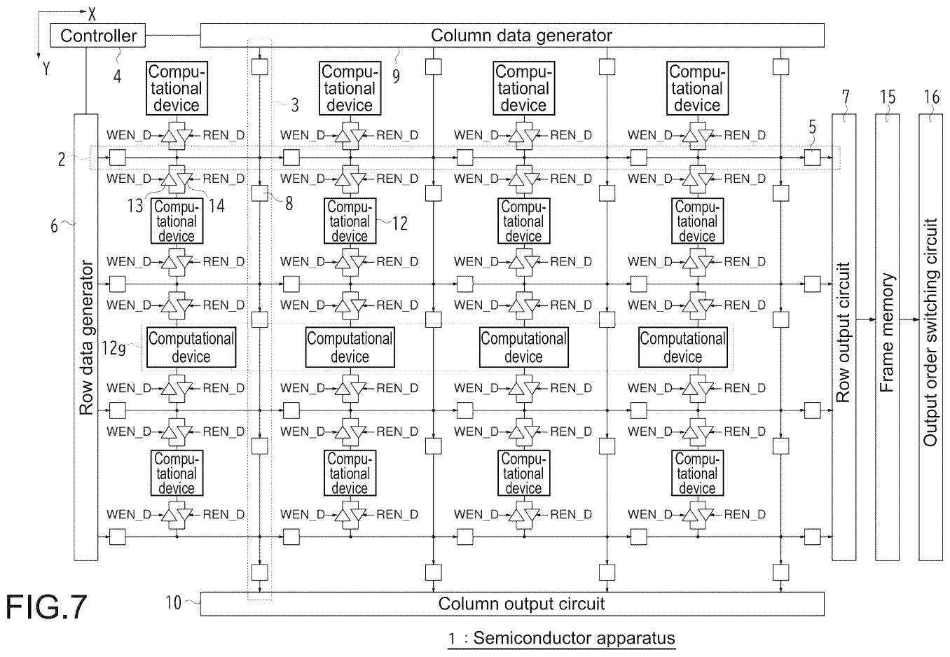

FIG. 7 is a block diagram of the semiconductor apparatus 1 according to the modification illustrated in FIG. 4. The semiconductor apparatus 1 illustrated in FIG. 7 includes a frame memory 15 and an output order switching circuit 16 that are connected to the row output circuit 7.

The frame memory 15 successively stores therein computation results for respective rows that are respectively transferred using the respective first data-transfer groups 2.

The output order switching circuit 16 selects one of a row-by-row basis and a column-by-column basis, and successively reads the computation results of computations performed by a plurality of computational devices 12 that are stored in the frame memory 15. Note that the frame memory 15 and the output order switching circuit 16 may be connected to the column output circuit 10.

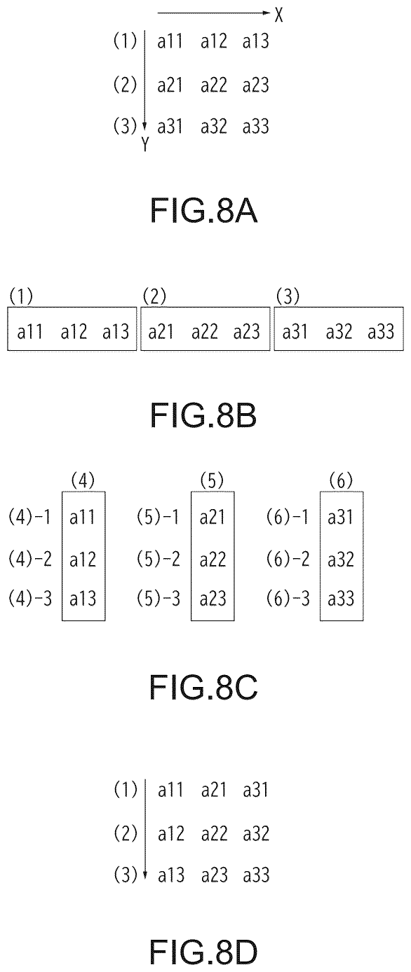

FIG. 8A illustrates arrangement of a plurality of computational devices 12. FIG. 8A illustrates an example of arranging nine computational devices 12 in total that include three computational devices 12 in the first direction X (for example, in a row direction) and three computational devices 12 in the second direction Y (for example, in a column direction), as illustrated in FIG. 6A. The nine computational devices 12 respectively output the computation results all, a12, a13, a21, a22, a23, a31, a32, and a33.

FIG. 8B illustrates an example of reading, on a row-by-row basis, computation results of computations performed by a plurality of computational devices 12, using a plurality of first data-transfer groups 2. The computation results all, a12, and a13 in a row (1) illustrated in FIG. 8A are output successively, the computation results a21, a22, and a23 in a row (2) illustrated in FIG. 8A are subsequently output successively, and the computation results a31, a32, and a33 in a row (3) illustrated in FIG. 8A are finally output successively.

FIG. 8C illustrates a storage region of the frame memory 15. The frame memory 15 successively stores therein, on a column-by-column basis, computation results of computations performed by the respective computational devices 12 that are read on a row-by-row basis. More specifically, the frame memory 15 stores therein the computation results a11, a21, and a31 in a column (4) ((4)-1, (4)-2, and (4)-3 in FIG. 8C), subsequently stores therein the computation results a12, a22, and a32 in a column (5) ((5)-1, (5)-2, and (5)-3 in FIG. 8C), and finally stores therein the computation results a13, a23, and a33 in a column (6) ((6)-1, (6)-2, and (6)-3 in FIG. 8C).

FIG. 8D illustrates an example of reading computation results from the frame memory 15. Reading of computation results in an order different from an order in which the computation results are stored in the frame memory 15 makes it possible to read the computation results in a state in which rows and columns are interchanged.

When computation results of computations performed by a plurality of computational devices 12 are stored in the frame memory 15 in a state in which rows and columns are interchanged, as described above, and when the computation results are read from the frame memory 15 in order of address, the computation results can be read in a state in which rows and columns are interchanged.

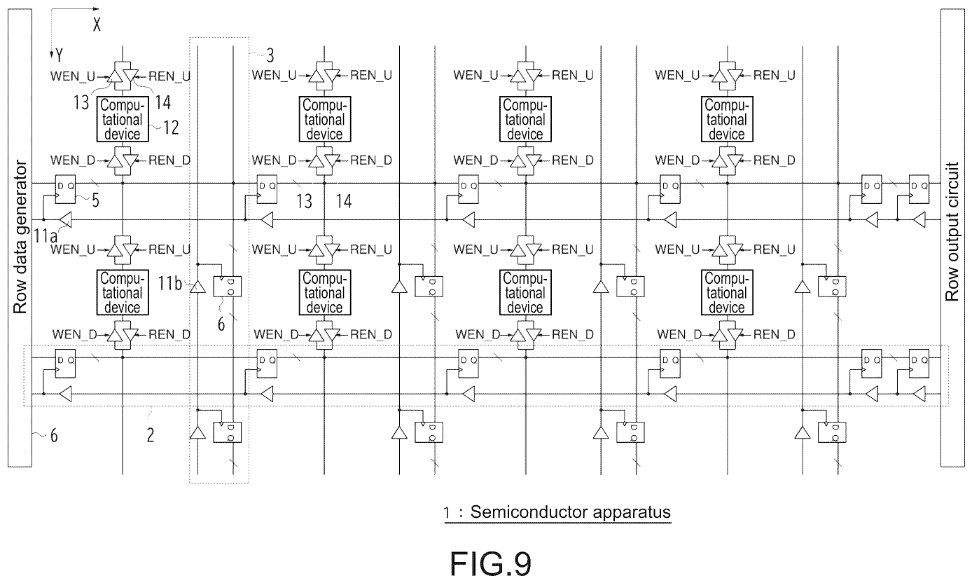

FIG. 9 is a block diagram illustrating more detailed configurations of the plurality of first data-transfer groups 2 and plurality of second data-transfer groups 3 illustrated in FIG. 4.

As illustrated in FIG. 9, each of the plurality of first data-transfer groups 2 includes the first flip-flops 5 connected to each other in series in the first direction X (for example, in a row direction), and the first clock buffers 11a connected to each other reversely to the transfer order of the first flip-flops 5.

Each of the plurality of second data-transfer groups 3 includes the second flip-flops 8 connected to each other in series in the second direction Y (for example, in a column direction), and the second clock buffers 11b connected to each other reversely to the transfer order of the second flip-flops 8.

Through the input buffer 13 and the output buffer 14, the computational device 12 is connected to a data output terminal of each of the first flip-flops 5 except for the first flip-flop 5 of a last stage, where the first flip-flops 5 are included in each first data-transfer group 2. Two pairs of the input buffer 13 and the output buffer 14 are connected to each computational device 12, where the two pairs are respectively situated above and below the computational device 12 in the column direction. The input buffer 13 above inputs, to the computational device 12, an output signal output from a corresponding first flip-flop 5 in the first data-transfer group 2 above when, for example, the level of an enable signal REN_U is high. The output buffer 14 above outputs a result of computation performed by the computational device 12 to the first data-transfer group 2 above when, for example, the level of an enable signal WEN_U is high. The input buffer 13 below inputs, to the computational device 12, an output signal output from a corresponding first flip-flop 5 in the first data-transfer group 2 below when, for example, the level of an enable signal REN_D is high. The output buffer 14 below outputs a computation result of computation performed by the computational device 12 to the first data-transfer group 2 below when, for example, the level of an enable signal WEN_D is high.

Through the output buffer 14, a computation result of computation performed by each computational device 12 is input to a data input terminal of a corresponding first flip-flop 5 in the first data-transfer group 2 and to a data input terminal of a corresponding second flip-flop 8 in the second data-transfer group 3. When the first clock buffers 11a supplying a clock signal CLK to the first flip-flops 5 propagates the clock signal CLK, the computation result of computation performed by each computational device 12 is transferred through the first data-transfer group 2 in the first direction X. When the second clock buffers 11b supplying the clock signal CLK to the second flip-flops 8 propagates the clock signal CLK, the computation result of computation performed by each computational device 12 is transferred through the second data-transfer group 3 in the second direction Y.

As described above, the direction in which computation results of computations performed by a plurality of computational devices 12 are transferred can be switched by determining whether to propagate a clock signal CLK using the first clock buffers 11a or the second clock buffers 11b.

The first data-transfer groups 2 of a plurality of first data-transfer groups 2 do not necessarily have to transfer data in the same direction, and a portion of the plurality of first data-transfer groups 2 may transfer the data in a direction opposite to a direction in which the first data-transfer groups 2 other than the portion perform the transfer. Likewise, the second data-transfer groups 3 of a plurality of second data-transfer groups 3 do not necessarily have to transfer data in the same direction, and a portion of the plurality of second data-transfer groups 3 may transfer the data in a direction opposite to a direction in which the second data-transfer groups 3 other than the portion perform the transfer.

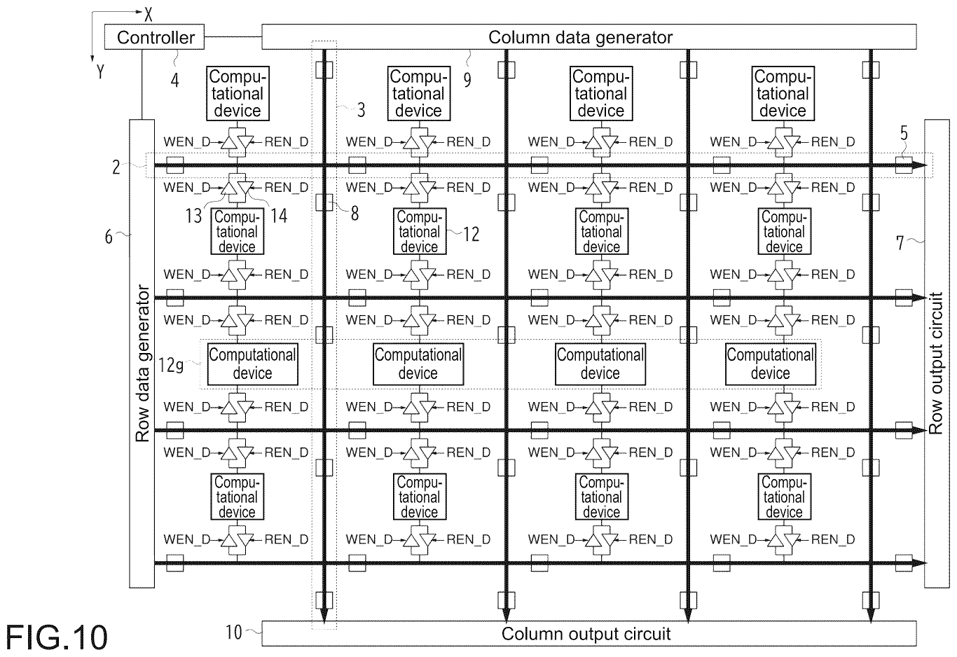

FIGS. 10 to 13 illustrate variations of typical data transfer directions in which a plurality of first data-transfer groups 2 transfers data and of typical data transfer directions in which a plurality of second data-transfer groups 3 transfers data. Arrows illustrated in FIGS. 10 to 13 indicate the data transfer directions.

FIG. 10 illustrates an example in which all of a plurality of first data-transfer groups 2 transfer data in the first direction X and all of a plurality of second data-transfer groups 3 transfer data in the second direction Y. In FIG. 10, the first data-transfer groups 2 of a plurality of first data-transfer groups 2 transfer, in parallel, data up to an end in the first direction X. The second data-transfer groups 3 of a plurality of second data-transfer groups 3 transfer, in parallel, data up to an end in the second direction Y.

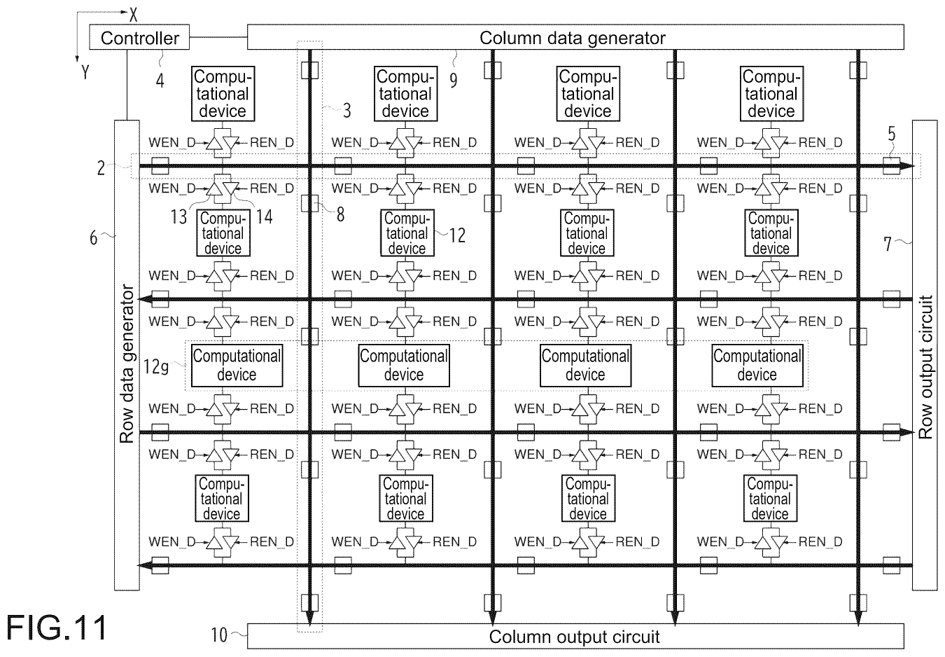

FIG. 11 illustrates an example in which the first data-transfer groups 2 of a plurality of first data-transfer groups 2 in odd-numbered rows transfer data in a direction opposite to a direction in which the first data-transfer groups 2 of the plurality of first data-transfer groups 2 in even-numbered rows transfer data. All of a plurality of second data-transfer groups 3 transfer data in the second direction YY. In FIG. 11, data transferred by a portion of the plurality of first data-transfer groups 2 up to a first end in the first direction X is transferred by the first data-transfer groups 2 other than the portion up to a second end in a direction opposite to the first direction X. The second data-transfer groups 3 of the plurality of second data-transfer groups 3 transfer, in parallel, data up to an end in the second direction Y.

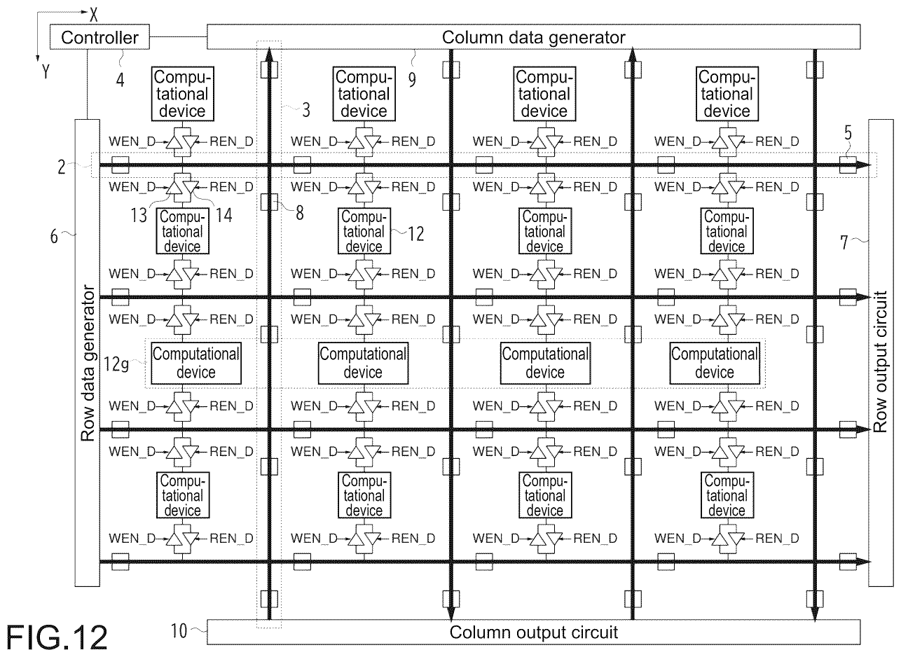

FIG. 12 illustrates an example in which the second data-transfer groups 3 of a plurality of second data-transfer groups 3 in odd-numbered columns transfer data in a direction opposite to a direction in which the second data-transfer groups 3 of the plurality of second data-transfer groups 3 in even-numbered columns transfer data. All of a plurality of first data-transfer groups 2 transfer data in the first direction X. In FIG. 12, the first data-transfer groups 2 of the plurality of first data-transfer groups transfer, in parallel, data up to an end in the first direction X. Data transferred by a portion of the plurality of second data-transfer groups 3 up to a first end in the second direction Y is transferred by the second data-transfer groups 3 other than the portion up to a second end in a direction opposite to the second direction Y.

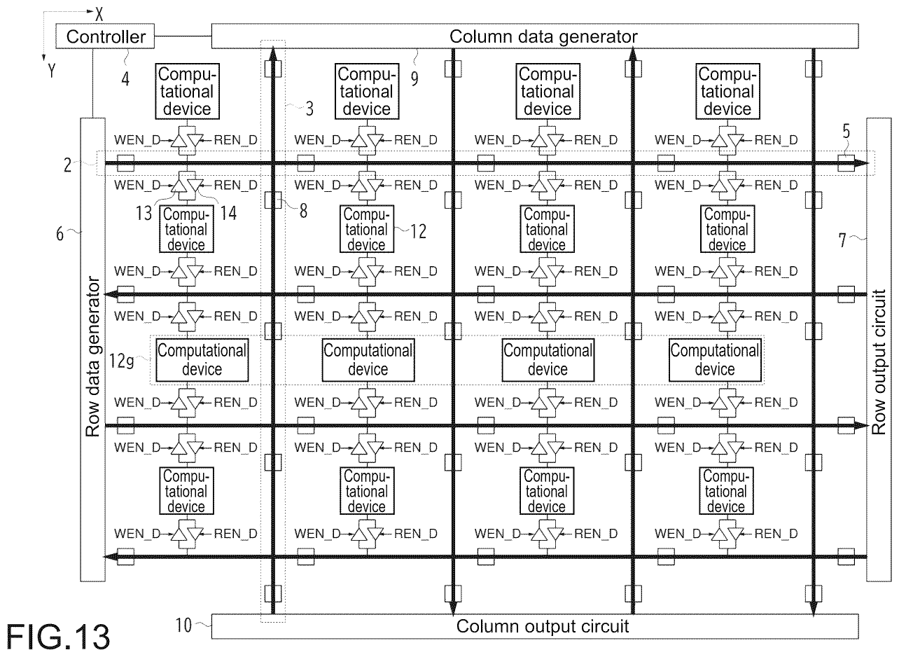

FIG. 13 illustrates an example in which the first data-transfer groups 2 of a plurality of first data-transfer groups 2 in odd-numbered rows transfer data in a direction opposite to a direction in which the first data-transfer groups 2 of the plurality of first data-transfer groups 2 in even-numbered rows transfer data and the second data-transfer groups 3 of a plurality of second data-transfer groups 3 in odd-numbered columns transfer data in a direction opposite to a direction in which the second data-transfer groups 3 of the plurality of second data-transfer groups 3 in even-numbered columns transfer data. In FIG. 13, data transferred by a portion of the plurality of first data-transfer groups 2 up to a first end in the first direction X is transferred by the first data-transfer groups 2 other than the portion up to a second end in a direction opposite to the first direction X, and data transferred by a portion of the plurality of second data-transfer groups 3 up to a third end in the second direction Y is transferred by the second data-transfer groups 3 other than the portion up to a fourth end in a direction opposite to the second direction Y.

In FIGS. 11 and 13, a plurality of first data-transfer groups 2 performs data transfer in the first direction X and data transfer in a direction opposite to the first direction X alternately in an order of arrangement in the second direction Y. In FIGS. 12 and 13, a plurality of second data-transfer groups 3 performs data transfer in the second direction Y and data transfer in a direction opposite to the first direction X alternately in an order of arrangement in the first direction X.

### Stacking Structure

The semiconductor apparatus 1 according to the present embodiment may be arranged on one semiconductor substrate.

Further, the semiconductor apparatus 1 according to the present embodiment may have a stacking structure obtained by stacking at least two semiconductor substrates.

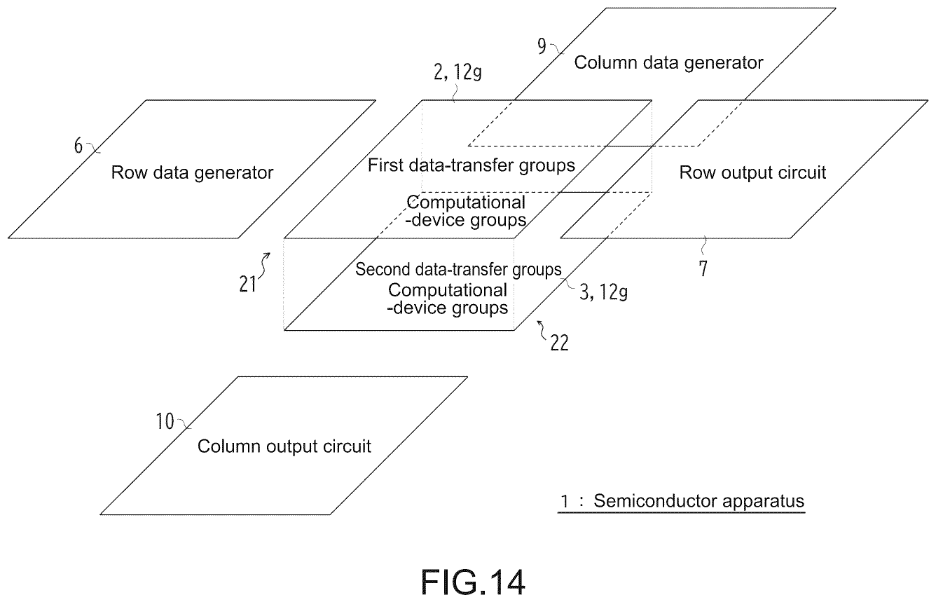

FIG. 14 is a schematic perspective view of the semiconductor apparatus 1 having a stacking structure according to the present embodiment. FIG. 14 illustrates an example in which the semiconductor apparatus 1 is formed by stacking two semiconductor substrates 21 and 22. A plurality of computational devices 12, a plurality of first data-transfer groups 2, the row data generator 6, and the row output circuit 7 are arranged on a first semiconductor substrate 21. A plurality of computational devices 12, a plurality of second data-transfer groups 3, the column data generator 9, and the column output circuit 10 are arranged on a second semiconductor substrate 22.

Signal transmission is performed between the first semiconductor substrate 21 and the second semiconductor substrate 22 using, for example, copper-copper connection (CCC), a via, or a bump. Either of the first semiconductor substrate 21 and the second semiconductor substrate 22 may be arranged above the other semiconductor substrate.

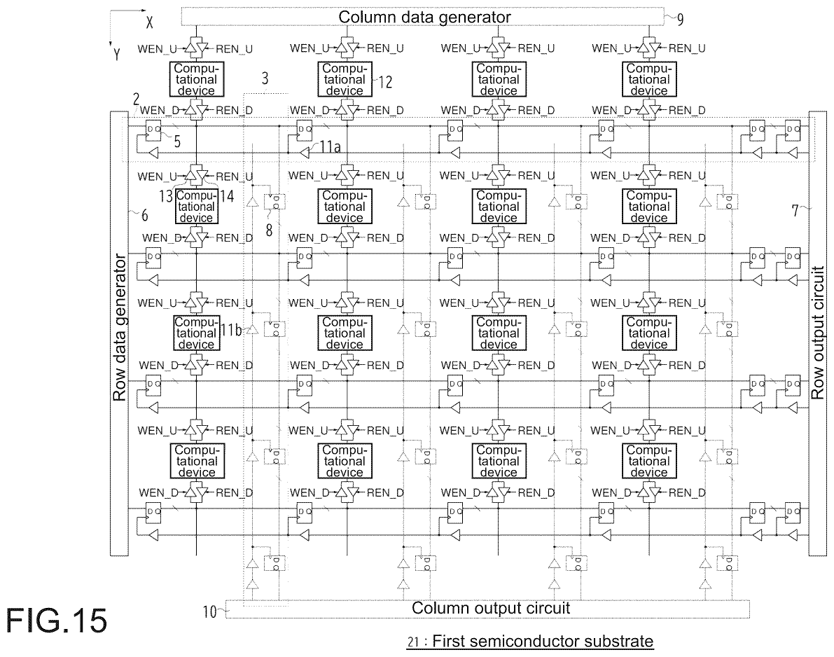

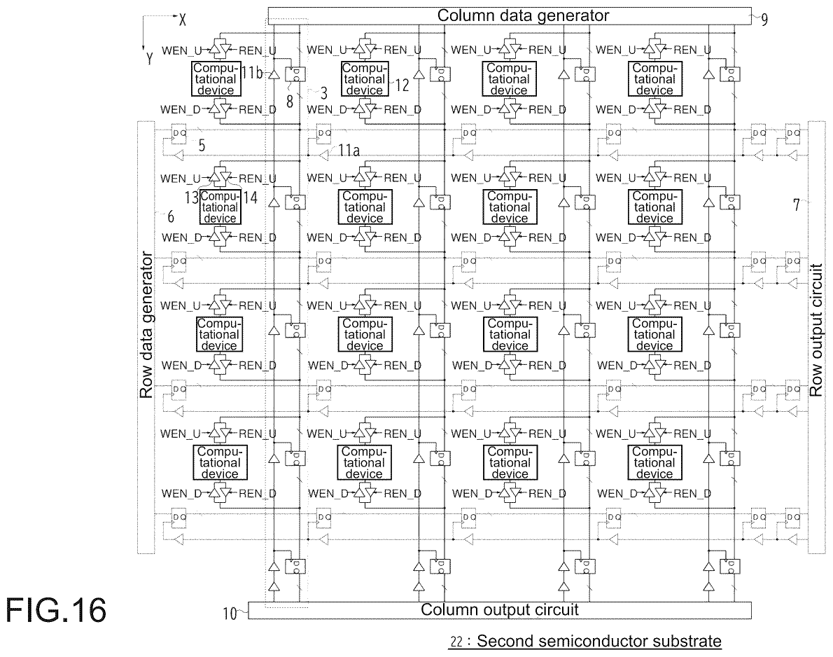

FIG. 15 is a block diagram of the first semiconductor substrate 21, and FIG. 16 is a block diagram of the second semiconductor substrate 22.

As illustrated in FIG. 15, a plurality of first data-transfer groups 2 arranged in the second direction Y, and a plurality of computational-device groups 12g arranged in the first direction X are arranged on the first semiconductor substrate 21. Each of the plurality of first data-transfer groups 2 includes the first flip-flops 5 connected to each other in series in the first direction X.

As illustrated in FIG. 16, a plurality of second data-transfer groups 3 arranged in the first direction X, and a plurality of computational-device groups 12g arranged in the first direction X are arranged on the second semiconductor substrate 22. Each of the plurality of second data-transfer groups 3 includes the second flip-flops 8 connected in series in the second direction Y.

The plurality of computational devices 12 on the first semiconductor substrate 21 and the plurality of computational devices 12 on the second semiconductor substrate 22 may be arranged not to overlap each other, or may be arranged to overlap each other.

FIG. 16 illustrates an example in which a computation result of computation performed by each computational device 12 is input to a data input terminal of the second data-transfer group 3 of a next stage in the same second data-transfer group 3 as the second flip-flop 8 inputting data to the computational device 12. This is merely an example, and a computation result of computation performed by each computational device 12 may be input to a data input terminal of one of the second data-transfer groups 3 in the second data-transfer group 3 different from the second data-transfer group 3 of the second flip-flop 8 inputting data to the computational device 12.

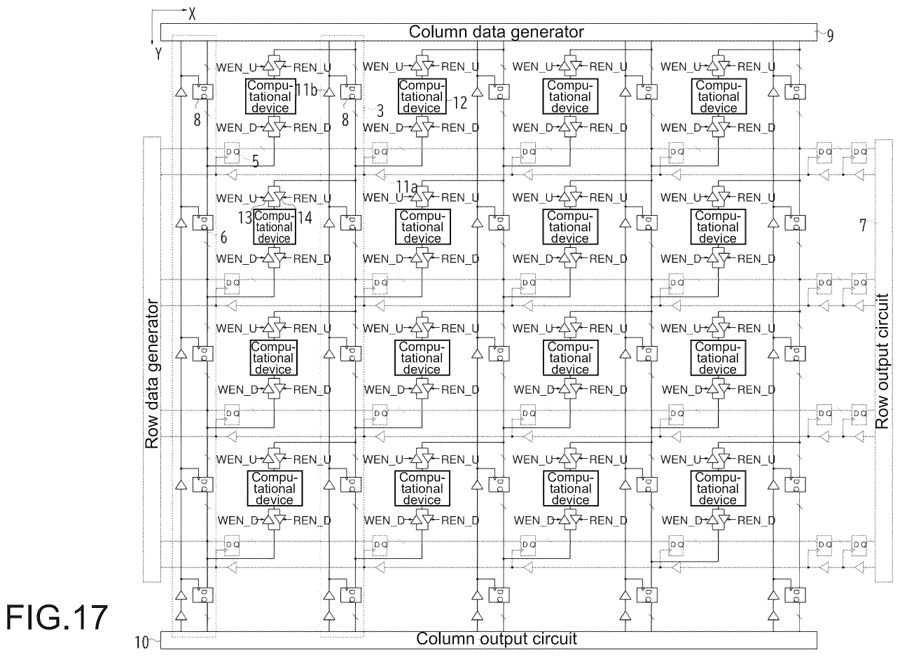

FIG. 17 is a block diagram of the second semiconductor substrate 22 according to a modification of FIG. 16. In FIG. 17, a computation result of computation performed by the computational device 12 is input to a data input terminal of a corresponding second flip-flop 8 in the second data-transfer group 3 different from the second data-transfer group 3 of the second flip-flop 8 inputting data to the computational device 12.

As described above, a computation result of computation performed by the computational device 12 may be input to a corresponding first flip-flop 5 in the first data-transfer group 2 different from the first data-transfer group 2 inputting data to the computational device 12, or to a corresponding second flip-flop 8 in the second data-transfer group 3 different from the second data-transfer group 3 inputting data to the computational device 12.

### Specific Example of Configuration of Computational Device 12

A plurality of computational devices 12 included in the semiconductor apparatus 1 according to the present embodiment may specifically perform any computational processes. Each computational device 12 can various computational processes, and details of a computational process to be performed may be switched depending on the time and the circumstances.

The plurality of first data-transfer groups 2 and the plurality of second data-transfer groups 3 transfer data including at least one of an opcode for each one of a plurality of computational devices 12, an operand, a computed time code, identification information regarding the computational device 12 to which next input is performed, or computation-termination information.

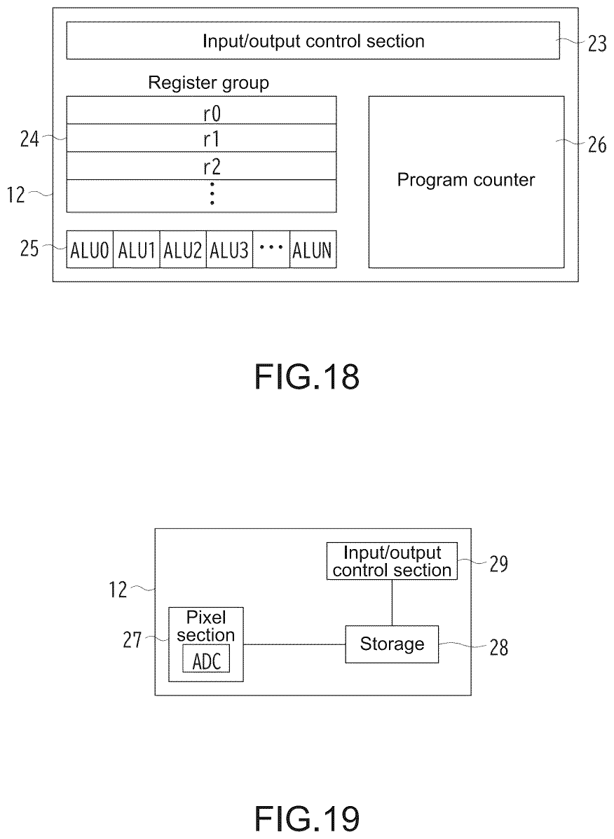

FIG. 18 is a block diagram illustrating a first example of an internal configuration of the computational device 12. The computational device 12 illustrated in FIG. 18 has an internal configuration close to an internal configuration of a processor, and includes an input/output control section 23, a register group 24, a plurality of arithmetic logic units (ALU) 25, and a program counter 26. The register group 24 includes, for example, a general-purpose register, an instruction register, and an index register.

FIG. 19 is a block diagram illustrating a second example of the internal configuration of the computational device 12 when the semiconductor apparatus 1 is a pixel-ADC image-capturing apparatus. The computational device 12 includes at least one pixel section 27 that includes an ADC, at least one storage 28, and an input/output control section 29.

As described above, the semiconductor apparatus 1 according to the present embodiment includes a plurality of first data-transfer groups 2 transferring data in the first direction X, and a plurality of second data-transfer groups 3 transferring data in the second direction Y, and performs individual switch control on a connection destination of an output terminal of each of the first flip-flops 5 and on a connection destination of an output terminal of each of the second flip-flops 8. This makes it possible to switch the data transfer direction as necessary. For example, computation results obtained by performing computation in a row direction using a plurality of computational devices 12 can be easily transposed to be output in a column direction.

### Application Example

The technology according to the present disclosure can be applied to various products. For example, the technology according to the present disclosure may be provided as an apparatus that is mounted on one of the types of mobile bodies such as vehicle, electric vehicle, hybrid electric vehicle, motorcycle, bicycle, personal mobility, airplane, drone, ship, robot, construction machinery, and agricultural machinery (tractor).

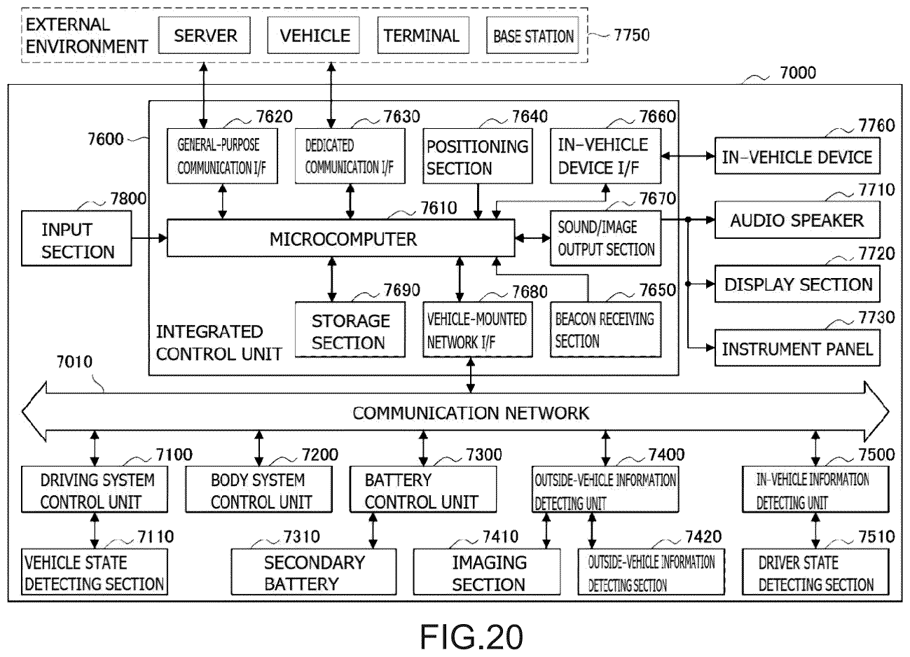

FIG. 20 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 20, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 20 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

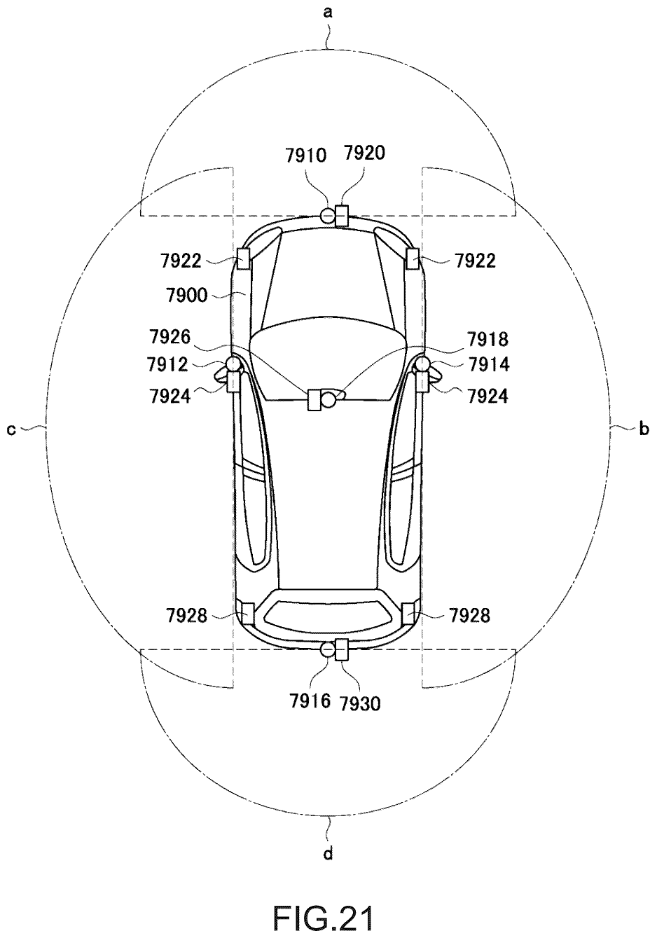

FIG. 21 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 21 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 20, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like.

Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle.

The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 20, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 20 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

In the vehicle control system 7000 described above, the semiconductor apparatus 1 according to the present embodiment that has been described with reference to, for example, FIG. 1 can be applied to the integrated control unit 7600 in the application example illustrated in FIG. 20.

Further, at least a portion of the structural elements of the semiconductor apparatus 1 described with reference to, for example, FIG. 1 may be implemented by a module for the integrated control unit 7600 illustrated in FIG. 20 (for example, an integrated circuit module formed using a single die). Alternatively, the semiconductor apparatus 1 described with reference to, for example, FIG. 1 may be implemented by a plurality of control units included in the vehicle control system 7000 illustrated in FIG. 20.

Note that the present technology may take the following configurations.
(1) A semiconductor apparatus, including:
   a plurality of first data-transfer groups each including first flip-flops that transfer data in a first direction, with first data-transfer groups of the plurality of first data-transfer groups being arranged in a second direction that intersects the first direction;
   a plurality of second data-transfer groups each including second flip-flops that transfer data in the second direction, with second data-transfer groups of the plurality of second data-transfer groups being arranged in the first direction; and
   a switch controller that performs individual switch control on a connection destination of an output terminal of each of the first flip-flops in the plurality of first data-transfer groups and on a connection destination of an output terminal of each of the second flip-flops in the plurality of second data-transfer groups.
(2) The semiconductor apparatus according to (1), in which
   an order of propagation of a clock signal input to the first flip-flops is reverse to an order of propagation of data input to the first flip-flops, and
   an order of propagation of a clock signal input to the second flip-flops is reverse to an order of propagation of data input to the second flip-flops.
(3) The semiconductor apparatus according to (1) or (2), further including
   a plurality of computational devices provided correspondingly to at least one of the plurality of first data-transfer groups or the plurality of second data-transfer groups, with computational devices of the plurality of computational devices being arranged in the first direction and in the second direction, in which
   each of the plurality of computational devices performs a computational process on the basis of an output signal output from the first flip-flop or second flip-flop corresponding to the computational device.
(4) The semiconductor apparatus according to (3), in which
   the plurality of computational devices performs at least one of four basic operations of arithmetic or analog-to-digital conversion.
(5) The semiconductor apparatus according to (3) or (4), in which
   each of the plurality of computational devices inputs a computation result to the first flip-flop of a next stage in the same first data-transfer group as the first flip-flop outputting the output signal, or to the second flip-flop of a next stage in the same second data-transfer group as the second flip-flop outputting the output signal.
(6) The semiconductor apparatus according to (3) or (4), in which
   each of the plurality of computational devices inputs a computation result to the first flip-flop in the first data-transfer group different from the first data-transfer group including the first flip-flop outputting the output signal, or to the second flip-flop in the second data-transfer group different from the second data-transfer group including the second flip-flop outputting the output signal.
(7) The semiconductor apparatus according to any one of (3) to (6), in which
   the switch controller performs individual switch control on whether a computation result of computation performed by each of the plurality of computational devices is to be transferred in the first direction using a corresponding one of the plurality of first data-transfer groups or in the second direction using a corresponding one of the plurality of second data-transfer groups.
(8) The semiconductor apparatus according to (7), further including
   a plurality of switching devices performing switching of an output-signal path according to the switch control performed by the switch controller, the switching being performed between each of the first flip-flops in the plurality of first data-transfer groups and a corresponding one of the second flip-flops in the plurality of second data-transfer groups.
(9) The semiconductor apparatus according to (8), in which
   switching devices of the plurality of switching devices are connected between an input node of each of the first flip-flops and an output node of a corresponding one of the plurality of computational devices and between an input node of a corresponding one of the second flip-flops and the output node of the computational device.
(10) The semiconductor apparatus according to any one of (3) to (9), further including:
   a plurality of first output buffers outputting, in the first or second direction, computation results of computations performed by the plurality of computational devices; and
   a plurality of second output buffers outputting, in a direction opposite to the first or second direction, the computation results of computations performed by the plurality of computational devices, in which
   the switch controller inputs the computation results of computations performed by the plurality of computational devices to the first flip-flops or the second flip-flops through the plurality of first output buffers or the plurality of second output buffers.
(11) The semiconductor apparatus according to any one of (3) to (10), in which
   the plurality of first data-transfer groups, the plurality of second data-transfer groups, and the plurality of computational devices are arranged in a single semiconductor layer or divided to be arranged in a plurality of semiconductor layers.
(12) The semiconductor apparatus according to any one of (3) to (11), in which
the plurality of first data-transfer groups and the plurality of second data-transfer groups transfer data including at least one of an opcode for each of the plurality of computational devices, an operand, a computed time code, identification information regarding the computational device to which next input is performed, or computation-termination information.
(13) The semiconductor apparatus according to any one of (1) to (12), in which
   the first data-transfer groups of the plurality of first data-transfer groups transfer, in parallel, data up to an end in the first direction, and
   the second data-transfer groups of the plurality of second data-transfer groups transfer, in parallel, data up to an end in the second direction.
(14) The semiconductor apparatus according to any one of (1) to (12), in which
   data transferred by a portion of the plurality of first data-transfer groups up to a first end in the first direction is transferred by the first data-transfer groups other than the portion up to a second end in a direction opposite to the first direction, and
   the second data-transfer groups of the plurality of second data-transfer groups transfer, in parallel, data up to an end in the second direction.
(15) The semiconductor apparatus according to any one of (1) to (12), in which
   the first data-transfer groups of the plurality of first data-transfer groups transfer, in parallel, data up to an end in the first direction, and
   data transferred by a portion of the plurality of second data-transfer groups up to a first end in the second direction is transferred by the second data-transfer groups other than the portion up to a second end in a direction opposite to the second direction.
(16) The semiconductor apparatus according to any one of (1) to (12), in which
   data transferred by a portion of the plurality of first data-transfer groups up to a first end in the first direction is transferred by the first data-transfer groups other than the portion up to a second end in a direction opposite to the first direction, and
   data transferred by a portion of the plurality of second data-transfer groups up to a third end in the second direction is transferred by the second data-transfer groups other than the portion up to a fourth end in a direction opposite to the second direction.
(17) The semiconductor apparatus according to any one of (1) to (9), in which
   the plurality of first data-transfer groups performs data transfer in the first direction and data transfer in a direction opposite to the first direction alternately in an order of arrangement in the second direction.
(18) The semiconductor apparatus according to any one of (1) to (12), in which
   the plurality of second data-transfer groups performs data transfer in the second direction and data transfer in a direction opposite to the first direction alternately in an order of arrangement in the first direction.
(19) The semiconductor apparatus according to any one of (1) to (18), in which
   each of the first flip-flops outputs, from an output node of the first flip-flop, a signal having the same logic as an input signal when a clock signal has a first logic, and causes the output node to exhibit a high impedance when the clock signal has a second logic, and
   each of the second flip-flops outputs, from an output node of the second flip-flop, a signal having the same logic as an input signal when a clock signal has the first logic, and causes the output node to exhibit a high impedance when the clock signal has the second logic.
(20) The semiconductor apparatus according to (19), in which
   each of the first flip-flops intakes the input signal when the clock signal has the second logic, and thereafter outputs, from the output node of the first flip-flop, a signal having the same logic as the intaken input signal when logic of the clock signal is changed to the first logic, and
   each of the second flip-flops intakes the input signal when the clock signal has the second logic, and thereafter outputs, from the output node of the second flip-flop, a signal having the same logic as the intaken input signal when logic of the clock signal is changed to the first logic.

Aspects of the present disclosure are not limited to the embodiments described above, but also include various modifications that could be conceived by those skilled in the art. Effects provided by the present disclosure are also not limited to the contents described above. In other words, various additions, modifications, and partial deletions may be made without departing from conceptual idea and spirit of the present disclosure that are derived from contents defined by the claims and equivalents thereof.

### REFERENCE SIGNS LIST

1 semiconductor apparatus
2 first data-transfer group
3 second data-transfer group
4 controller
5 first output buffer
5 first flip-flop
6 row data generator
7 row output circuit
8 second output buffer
8 second flip-flop
9 column data generator
10 column output circuit
11 clock buffer
11a first clock buffer
11b second clock buffer
12 computational device
12g computational-device group
13 input buffer
14 output buffer
15 frame memory
16 output order switching circuit
21 first semiconductor substrate
22 second semiconductor substrate
23 input/output control section
24 register group
25 arithmetic logic unit
26 program counter
27 including pixel section
28 storage
29 input/output control section

1. A semiconductor apparatus, comprising:
a plurality of first data-transfer groups each including first flip-flops that transfer data in a first direction, with first data-transfer groups of the plurality of first data-transfer groups being arranged in a second direction that intersects the first direction;
a plurality of second data-transfer groups each including second flip-flops that transfer data in the second direction, with second data-transfer groups of the plurality of second data-transfer groups being arranged in the first direction; and
a switch controller that performs individual switch control on a connection destination of an output terminal of each of the first flip-flops in the plurality of first data-transfer groups and on a connection destination of an output terminal of each of the second flip-flops in the plurality of second data-transfer groups.

2. The semiconductor apparatus according to claim 1, wherein
an order of propagation of a clock signal input to the first flip-flops is reverse to an order of propagation of data input to the first flip-flops, and
an order of propagation of a clock signal input to the second flip-flops is reverse to an order of propagation of data input to the second flip-flops.

3. The semiconductor apparatus according to claim 1, further comprising
a plurality of computational devices provided correspondingly to at least one of the plurality of first data-transfer groups or the plurality of second data-transfer groups, with computational devices of the plurality of computational devices being arranged in the first direction and in the second direction, wherein
each of the plurality of computational devices performs a computational process on a basis of an output signal output from the first flip-flop or second flip-flop corresponding to the computational device.

4. The semiconductor apparatus according to claim 3, wherein
the plurality of computational devices performs at least one of four basic operations of arithmetic or analog-to-digital conversion.

5. The semiconductor apparatus according to claim 3, wherein
each of the plurality of computational devices inputs a computation result to the first flip-flop of a next stage in the same first data-transfer group as the first flip-flop outputting the output signal, or to the second flip-flop of a next stage in the same second data-transfer group as the second flip-flop outputting the output signal.

6. The semiconductor apparatus according to claim 3, wherein
each of the plurality of computational devices inputs a computation result to the first flip-flop in the first data-transfer group different from the first data-transfer group including the first flip-flop outputting the output signal, or to the second flip-flop in the second data-transfer group different from the second data-transfer group including the second flip-flop outputting the output signal.

7. The semiconductor apparatus according to claim 3, wherein
the switch controller performs individual switch control on whether a computation result of computation performed by each of the plurality of computational devices is to be transferred in the first direction using a corresponding one of the plurality of first data-transfer groups or in the second direction using a corresponding one of the plurality of second data-transfer groups.

8. The semiconductor apparatus according to claim 7, further comprising
a plurality of switching devices performing switching of an output-signal path according to the switch control performed by the switch controller, the switching being performed between each of the first flip-flops in the plurality of first data-transfer groups and a corresponding one of the second flip-flops in the plurality of second data-transfer groups.

9. The semiconductor apparatus according to claim 8, wherein
switching devices of the plurality of switching devices are connected between an input node of each of the first flip-flops and an output node of a corresponding one of the plurality of computational devices and between an input node of a corresponding one of the second flip-flops and the output node of the computational device.

10. The semiconductor apparatus according to claim 3, further comprising:
a plurality of first output buffers outputting, in the first or second direction, computation results of computations performed by the plurality of computational devices; and
a plurality of second output buffers outputting, in a direction opposite to the first or second direction, the computation results of computations performed by the plurality of computational devices, wherein
the switch controller inputs the computation results of computations performed by the plurality of computational devices to the first flip-flops or the second flip-flops through the plurality of first output buffers or the plurality of second output buffers.

11. The semiconductor apparatus according to claim 3, wherein
the plurality of first data-transfer groups, the plurality of second data-transfer groups, and the plurality of computational devices are arranged in a single semiconductor layer or divided to be arranged in a plurality of semiconductor layers.

12. The semiconductor apparatus according to claim 3, wherein
the plurality of first data-transfer groups and the plurality of second data-transfer groups transfer data including at least one of an opcode for each of the plurality of computational devices, an operand, a computed time code, identification information regarding the computational device to which next input is performed, or computation-termination information.

13. The semiconductor apparatus according to claim 1, wherein
the first data-transfer groups of the plurality of first data-transfer groups transfer, in parallel, data up to an end in the first direction, and
the second data-transfer groups of the plurality of second data-transfer groups transfer, in parallel, data up to an end in the second direction.

14. The semiconductor apparatus according to claim 1, wherein
data transferred by a portion of the plurality of first data-transfer groups up to a first end in the first direction is transferred by the first data-transfer groups other than the portion up to a second end in a direction opposite to the first direction, and
the second data-transfer groups of the plurality of second data-transfer groups transfer, in parallel, data up to an end in the second direction.

15. The semiconductor apparatus according to claim 1, wherein
the first data-transfer groups of the plurality of first data-transfer groups transfer, in parallel, data up to an end in the first direction, and
data transferred by a portion of the plurality of second data-transfer groups up to a first end in the second direction is transferred by the second data-transfer groups other than the portion up to a second end in a direction opposite to the second direction.

16. The semiconductor apparatus according to claim 1, wherein
data transferred by a portion of the plurality of first data-transfer groups up to a first end in the first direction is transferred by the first data-transfer groups other than the portion up to a second end in a direction opposite to the first direction, and
data transferred by a portion of the plurality of second data-transfer groups up to a third end in the second direction is transferred by the second data-transfer groups other than the portion up to a fourth end in a direction opposite to the second direction.

17. The semiconductor apparatus according to claim 1, wherein
the plurality of first data-transfer groups performs data transfer in the first direction and data transfer in a direction opposite to the first direction alternately in an order of arrangement in the second direction.

18. The semiconductor apparatus according to claim 1, wherein
the plurality of second data-transfer groups performs data transfer in the second direction and data transfer in a direction opposite to the first direction alternately in an order of arrangement in the first direction.

19. The semiconductor apparatus according to claim 1, wherein
each of the first flip-flops outputs, from an output node of the first flip-flop, a signal having the same logic as an input signal when a clock signal has a first logic, and causes the output node to exhibit a high impedance when the clock signal has a second logic, and
each of the second flip-flops outputs, from an output node of the second flip-flop, a signal having the same logic as an input signal when a clock signal has the first logic, and causes the output node to exhibit a high impedance when the clock signal has the second logic.

20. The semiconductor apparatus according to claim 19, wherein
each of the first flip-flops intakes the input signal when the clock signal has the second logic, and thereafter outputs, from the output node of the first flip-flop, a signal having the same logic as the intaken input signal when logic of the clock signal is changed to the first logic, and
each of the second flip-flops intakes the input signal when the clock signal has the second logic, and thereafter outputs, from the output node of the second flip-flop, a signal having the same logic as the intaken input signal when logic of the clock signal is changed to the first logic.
